(19) United States
(12) Patent Application Publication
(10) Pub. No.: US 2024/0378451 A1
(43) Pub. Date: Nov. 14, 2024

(54) MACHINE LEARNING DEVICE, MACHINE LEARNING METHOD, AND COMPUTER PROGRAM PRODUCT

(71) Applicant: KABUSHIKI KAISHA TOSHIBA, Tokyo (JP)

(72) Inventors: Toshimitsu KANEKO, Kawasaki (JP); Gaku MINAMOTO, Kawasaki (JP)

(73) Assignee: KABUSHIKI KAISHA TOSHIBA, Tokyo (JP)

(21) Appl. No.: 18/581,099

(22) Filed: Feb. 19, 2024

(30) Foreign Application Priority Data
May 10, 2023 (JP) 2023-078022

(51) Int. Cl. G06N 3/092

(52) U.S. Cl. CPC G06N 3/092

(57) ABSTRACT

According to an embodiment, a machine learning device is con configured to: acquire observation information including information on a speed of a control target point at a control target time; output control information including information on speed control of the control target point, the control information being determined in accordance with the observation information and a control policy; determine a corrected reward obtained by correcting a reward in accordance with a speed of the control target point included in the observation information, the reward being higher as an error between a value of an evaluation parameter and a goal is smaller, the evaluation parameter being a parameter other than a speed derived from the observation information; and perform reinforcement learning of the control policy based on the observation information and the corrected reward.

### CROSS-REFERENCE TO RELATED APPLICATIONS

This application is based upon and claims the benefit of priority from Japanese Patent Application No. 2023-078022, filed on May 10, 2023; the entire contents of which are incorporated herein by reference.

### FIELD

An embodiment described herein relates generally to a machine learning device, a machine learning method, and a computer program product.

### BACKGROUND

Attempts have been made to apply reinforcement learning to learning of various controls. Japanese Patent No. 6077617 discloses a method for learning speed control to minimize a deviation from a command path by calculating a reward based on a deviation from the command path and performing reinforcement learning. M. Schmitz, F. Pinsker, A. Ruhri, B. Jiang and G. Safronov, “Enabling Rewards for Reinforcement Learning in Laser Beam Welding processes through Deep Learning,” 19th IEEE International Conference on Machine Learning and Applications (ICMLA), 14-17 Dec. 2020 discloses a method for learning welding control including welding speed by reinforcement learning in laser welding by calculating a reward based on the difference between a desired bead width and a generated bead width. Non-Patent Literature 2 discloses a method for learning control policies by using accumulated experience data by replacing goals when a system is controlled to meet a given goal.

Reinforcement learning is a technique for learning a policy that maximizes an expected value of a discounted cumulative reward. The discounted cumulative reward is the sum of rewards earned since the present time, multiplied by a weight that is smaller as the time difference from the present time is greater. A control method that reduces errors can be learned by performing reinforcement learning using rewards calculated based on errors, as disclosed in Japanese Patent No. 6077617 and M. Schmitz, F. Pinsker, A. Ruhri, B. Jiang and G. Safronov, “Enabling Rewards for Reinforcement Learning in Laser Beam Welding processes through Deep Learning,” 19th IEEE International Conference on Machine Learning and Applications (ICMLA), 14-17 Dec. 2020. However, when the speed of a control target point changes, the travel distance per unit time varies with speed and, therefore, the discounted cumulative error varies not only with the error calculated based on a trajectory but also with the speed. For this reason, with the conventional arts, it is difficult to minimize the average error of a trajectory of a control target point including speed control with respect to a goal trajectory.

### BRIEF DESCRIPTION OF THE DRAWINGS

FIG. 1 is a schematic diagram of a learning system;

FIG. 2 is a diagram illustrating the correspondence between a goal of an evaluation parameter at the location of a control target point and an evaluation parameter value actually achieved;

FIG. 3 is a functional block diagram of a machine learning device;

FIG. 4 is a schematic diagram of a display screen;

FIG. 5A is a schematic diagram of a display screen;

FIG. 5B is a schematic diagram of a display screen;

FIG. 6 is a flowchart illustrating information processing; and

FIG. 7 is a hardware diagram.

### DETAILED DESCRIPTION

According to an embodiment, A machine learning device includes an acquisition unit, an output unit, a corrected reward determination unit, and a learning unit. The acquisition unit is configured to acquire observation information including information on a speed of a control target point at a control target time. The output unit is configured to output control information including information on speed control of the control target point, the control information being determined in accordance with the observation information and a control policy. The corrected reward determination unit configured to determine a corrected reward obtained by correcting a reward in accordance with a speed of the control target point included in the observation information, the reward being higher as an error between an evaluation parameter value and a goal is smaller, the evaluation parameter being a parameter other than a speed derived from the observation information. The learning unit is configured to perform reinforcement learning of the control policy based on the observation information and the corrected reward.

A machine learning program, a machine learning method, and a machine learning device according to embodiments will be described in detail below with reference to the accompanying drawings.

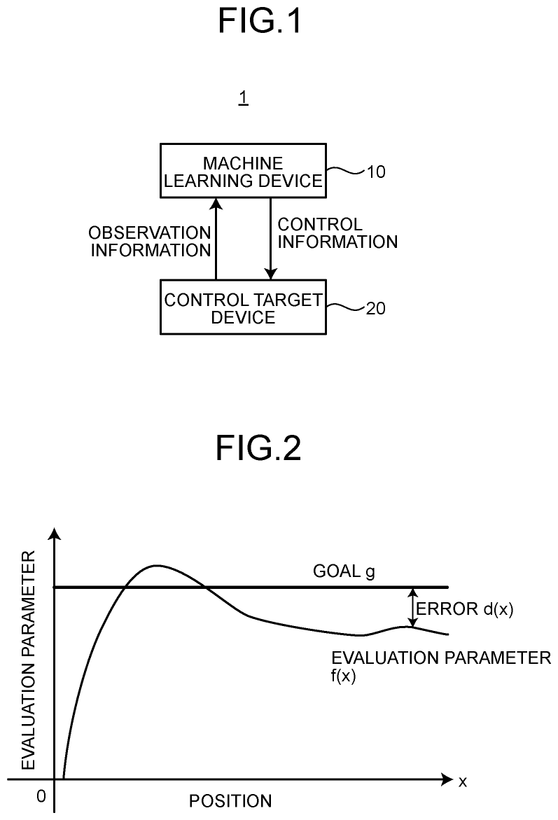

FIG. 1 is a schematic diagram of an example of a learning system 1 according to the present embodiment.

The learning system 1 includes a machine learning device 10 and a control target device 20. The machine learning device 10 and the control target device 20 are communicably connected.

The machine learning device 10 is an information processing device that performs reinforcement learning. In other words, the machine learning device 10 is an agent responsible for learning. The machine learning device 10 is a computer for executing the machine learning program of the present embodiment.

The control target device 20 is a control target targeted by the machine learning device 10. In other words, the control target device 20 is a target to which control information determined in accordance with a control policy learned by the machine learning device 10 is applied.

The control target device 20 is, for example, a device such as a robot such as a Cartesian coordinate robot or a multi-joint robot, a machine tool for laser machining or laser welding, and an unmanned movable body such as an unmanned vehicle or a drone. The control target device 20 may be a computer simulator that simulates the operation of such devices.

The machine learning device 10 learns a control policy so that a control target point controlled by the control target device 20 achieves a goal in an evaluation parameter. In other words, the machine learning device 10 learns a control policy that minimizes the average error of a control target point with respect to a goal.

The control target point is a point to be controlled at each of control target times successive in a time series. When the control target device 20 is a robot, the control target point is, for example, the distal end of a robot arm or a specific position of an end effector. When the control target device 20 is a machine tool for laser machining or laser welding, the control target point is, for example, a laser radiation point in laser machining. When the control target device 20 is an unmanned movable body such as an unmanned vehicle or a drone, the control target point is, for example, the center of gravity of the unmanned movable body.

In reinforcement learning, the learning of the machine learning device 10 proceeds through the interaction between the machine learning device 10 responsible for learning and the control target device 20 to be controlled.

Specifically, the control target device 20 outputs observation information on a control target point at each control target time to the machine learning device 10. The machine learning device 10 determines control information representing an action in accordance with the observation information acquired from the control target device 20 and a control policy and outputs the control information to the control target device 20. A series of these processes is repeated, so that the learning of the machine learning device 10 proceeds.

The observation information is information that represents a state of a control target point at a control target time and is necessary for controlling the control target device 20. In the present embodiment, the observation information at least includes information on the speed of a control target point at a control target time.

The information on the speed of a control target point may be any information that can specify the speed of a control target point at a control target time. Specifically, the information on the speed of a control target point is information that represents at least one of the position, the speed, the acceleration, and the travel distance per unit time of a control target point at a control target time.

The control information is information used for controlling the action of a control target point. In the present embodiment, the control information at least includes information on speed control of a control target point.

Specifically, when the control target device 20 is a drone, the control information is, for example, the speed or the acceleration in each direction of the forward, backward, left, right, up, and down, and the observation information is information necessary for controlling the drone, such as information on the position, the speed, and the surroundings of the drone. The information on the surroundings is, for example, an image of surroundings captured by a camera, a distance image, an occupancy grid map, and the like.

When the control target device 20 is a multi-joint robot, the control information is the torque and the angle of each joint, and the position, posture, and speed of the control target point. The observation information is information necessary for controlling the multi-joint robot, such as the angle and the angular speed of each joint, the position, posture, and speed of the control target point, and information on the work environment. The information on the work environment is, for example, an image of surroundings captured by a camera, a distance image, and the like.

When the control target device 20 is a laser welding machine, the control information is welding speed, welding acceleration, laser power, spot diameter, and the like. The observation information is information necessary for controlling the laser welding machine, such as a laser radiation position, a radiation speed, a spot diameter, the gap between materials, the width of bead or molten pool, and information on the vicinity of a weld position. The information on the vicinity of a weld position is, for example, an image of the surroundings of a weld position captured by a camera, a temperature distribution, and the like.

The basic concepts of reinforcement learning will now be described. In the present embodiment, goal-conditioned reinforcement learning is used as reinforcement learning.

The goal-conditioned reinforcement learning is a method of learning a control policy that determines an action aₜ from a state sₜ input at a certain control target time t when a goal g is given.

The state sₜ corresponds to the observation information or a part thereof at the control target time t. The action aₜ corresponds to the control information.

The control policy is a probability distribution expressed by π(aₜ|sₜ,g). The control policy π(aₜ|sₜ,g) is learned, for example, by a neural network that outputs probability values or parameters of a probability model.

The goal-conditioned reinforcement learning aims to learn a control policy π(aₜ|sₜ,g) that maximizes the expected value of a discounted cumulative reward given by the following Formula (1). The discounted cumulative reward is the sum of rewards earned since the present time, multiplied by a weight that is smaller as the time difference from the present time is greater.

$${\sum }_{k = 0}^{∞} {γ}^{k} r ( {s}_{t + k} , {a}_{t + k} , g ) \qquad Formula ( 1 )$$

In Formula (1), r(sₜ,aₜ,g) represents the reward calculated aₜ time t+1 as a result of the action aₜ taken in the state sₜ when the goal g is given. In Formula (1), γ is a discount rate. k is an integer equal to or greater than 0.

The discount rate γ is a parameter of 0 through 1, both inclusive, for adjusting how much the reward in the distant future is taken into consideration to determine an action. In other words, the discount rate γ is a hyperparameter for adjusting how distant future is taken into consideration. A parameter for evaluating the reward earned in more distant future aₜ a greater discount is used for the discount rate γ. The discount rate γ also serves as regularization to stabilize learning.

Various algorithms are known for reinforcement learning. Many of them include learning steps of a value function V(sₜ,g) and an action value function Q(sₜ,aₜ,g).

The value function V(sₜ,g) is the estimated value of the discounted cumulative reward earned by acting from the state sₜ in accordance with the present control policy π(aₜ|sₜ,g) when the goal g is given. The value of the value function V(sₜ,g) is updated (learned) by an updating formula given by the following Formula (2) when a method called temporal difference (TD) learning is used.

$$V ( {s}_{t} , g ) ← V ( {s}_{t} , g ) + α [ r ( {s}_{t} , {a}_{t} , g ) + γ V ( {s}_{t + 1} , g ) - V ( {s}_{t} , g ) ] \qquad Formula ( 2 )$$

In Formula (2), α is a learning rate.

The action value function Q(sₜ,aₜ,g) is the estimated value of the discounted cumulative reward earned by acting in accordance with the present control policy π(aₜ|sₜ,g) after taking the action aₜ in the state sₜ when the goal g is given. The value of the action value function Q(sₜ,aₜ,g) is updated (learned) by an updating formula given by the following Formula (3) in TD learning.

$$Q ( {s}_{t} , {a}_{t} , g ) ← Q ( {s}_{t} , {a}_{t} , g ) + α [ r ( {s}_{t} , {a}_{t} , g ) + γ \int π ( a \vert {s}_{t + 1} , g ) Q ( {s}_{t + 1} , a , g ) da - Q ( {s}_{t} , {a}_{t} , g ) ] \qquad Formula ( 3 )$$

In Formula (3), the following Expression (4) below is generally difficult to calculate.

$$\int {π}_{θ} ( a \vert {s}_{t + 1} , g ) Q ( {s}_{t + 1} , a , g ) d a \qquad Expression ( 4 )$$

For this reason, instead of Expression (4) in Formula (3), the value function V(sₜ,g) is used, or the action value function Q(sₜ+1,a,g) with only actions a sampled in accordance with the control policy π(a|sₜ₊₁,g) is used.

The value function V (sₜ, g) and the action value function Q(sₜ,aₜ,g) are learned, for example, with a linear model or a neural network.

A method of learning a control policy such that a control target achieves a goal in an evaluation parameter using goal-conditioned reinforcement learning will now be described.

FIG. 2 illustrates an example of the correspondence between a goal g of an evaluation parameter at a position x of a control target point and the value of an evaluation parameter f(x) actually achieved.

The position x is a distance from a reference position on the trajectory of the control target point planned in advance. The trajectory of the control target point is the trajectory of the control target point at each of the control target times planned in advance. When the planned trajectory of the control target point is a straight line, the planned trajectory may be used as it is as the x axis having the reference position as the origin.

The goal is a desired value of the evaluation parameter f(x).

The evaluation parameter f(x) is a parameter other than speed that is derived from observation information. The derivation means any one of calculation, computation, determination, identification, and reading. As previously mentioned, the observation information depends on the kinds of the control target device 20. Examples include: information necessary for controlling drones, such as information on position, speed, and surroundings of drones; information necessary for controlling multi-joint robots, such as the angle and the angular speed of each joint, the position, posture, and speed of the control target point, and information on the work environment; and welding speed, welding acceleration, laser power, spot diameter, and the like. The observation information includes information necessary for controlling a laser welding machine, such as a laser radiation position, a radiation speed, a spot diameter, the gap between materials, the width of bead or molten pool, and information on the vicinity of a weld position. The evaluation parameter f(x) is a parameter other than speed, among these parameters derived from the observation information.

Specifically, the evaluation parameter f(x) and the goal g are as follows. For example, in the case of drone control, the distance between the set trajectory, which is the trajectory of the control target point set in advance, and the present position of the control target point is set as the evaluation parameter f(x), and the distance 0 (zero) is given as the goal g. In the case of laser welding control, the bead width or penetration depth is set as the evaluation parameter f(x), and a positive constant is given as the goal g.

In the goal-conditioned reinforcement learning, reinforcement learning is performed so that the goal is achieved. The reward is therefore defined such that the smaller the error d(x) between the goal g and the value of the evaluation parameter f(x) actually achieved, the greater reward r(sₜ,aₜ,g) is given. For example, the L1 distance or the L2 distance can be used as the error d(x). In the goal-conditioned reinforcement learning, learning is performed by defining the reward r(sₜ,aₜ,g) as given by Equation (5) below by integrating the error d(x) from time t to t+1 and multiplying the integral by −1.

$$r ( {s}_{t} , {a}_{t} , g ) = - {\int }_{t}^{t + 1} {γ}^{τ - t} d ( x ( τ ) ) d τ \qquad Equation ( 5 )$$

In Equation (5), x(t) represents the position of the control target point at time t. Time t has the same meaning as the control target time t.

The definition of the reward given by Equation (5) means learning of the control policy π(aₜ|sₜ,g) that minimizes the expected value of the objective function given by the following Expression (6).

$${\int }_{0}^{∞} {γ}^{τ} d ( x ( t + τ ) ) d τ \qquad Equation ( 6 )$$

Expression (6) is the objective function that represents the average error of the control target point with respect to the goal. Specifically, the average error given by Expression (6) represents an integral where the error d(x) between the goal trajectory, which is the trajectory of the control target point planned in advance, and the actual trajectory of the control target point is integrated along the goal trajectory.

Alternatively, as an approximation of the definition of the reward given by Equation (5), the reward r(sₜ,aₜ,g) is defined as r(sₜ,aₜ,g)=d(x(t+1)), using only the error d(x) aₜ time t+1. The definition of the reward given by this equation corresponds to learning of the control policy π(aₜ|sₜ, g) that minimizes the expected value of the objective function given by the following Expression (7) that discretely calculates Expression (6) above.

$${\sum }_{c = 0}^{∞} {γ}^{k} d ( x ( c + k ) ) \qquad Equation ( 7 )$$

In the control of the control target device 20 such as a drone, when the difference between the trajectory of the control target point planned in advance and the actual trajectory is to be minimized, the objective function introducing the discount rate γ for learning by reinforcement learning is given by the following Expression (8).

$${\int }_{0}^{∞} {γ}^{τ} e ( x ) d x \qquad Equation ( 8 )$$

Expression (8) is the objective function that represents the average error of the control target point with respect to the goal. Specifically, the average error given by Expression (8) represents an integral where the error d(x) between the goal trajectory, which is the trajectory of the control target point planned in advance, and the actual trajectory of the control target point is integrated along the goal trajectory.

In the control target device 20 for laser welding or the like, when the bead width or penetration depth is to be controlled to a value planned in advance, Expression (8) is the objective function as well.

Here, when the speed of the control target point is constant, the minimization of the expected value of the objective function given by Expression (6) above is the same as the minimization of the objective function given by Expression (8) above. However, when the speed of the control target point is not constant, the minimization of the expected value of the objective function given by Expression (6) above is different from the minimization of the objective function given by Expression (8) above. Specifically, for example, when the value of the error d(x) is large, the deviation from the goal g is larger at a larger speed than at a smaller speed, and the influence on Expression (8) is greater. However, since Expression (6) integrates the error d(x) with respect to time, the influence of speed is not taken into consideration.

For this reason, in the conventional reinforcement learning, when the control policy for the control target point including speed control is learned by reinforcement learning, it has been impossible to perform reinforcement learning that optimizes Expression (8) which is the original objective function. In other words, in the conventional reinforcement learning, when the control policy for the control target point including speed control is learned by reinforcement learning, it has been difficult to minimize the average error of the control target point with respect to the goal.

In the machine learning device 10 of the present embodiment, the control policy is learned by reinforcement learning using a corrected reward in which the reward is corrected in accordance with the speed of the control target point included in the observation information. By using the corrected reward, the machine learning device 10 of the present embodiment can prevent change in speed from influencing the value of the average error and can learn a control policy that minimizes the average error.

Furthermore, the machine learning device 10 of the present embodiment learns a control policy by reinforcement learning, using a corrected discount rate in which the discount rate of the reward is corrected in accordance with the travel distance of the control target point, instead of the discount rate of the reward. By using the corrected discount rate, the machine learning device 10 of the present embodiment can prevent change in speed from influencing the value of the discounted cumulative reward and can learn a control policy that minimizes the average error.

In other words, the machine learning device 10 of the present embodiment provides a method for learning a control policy that minimizes the average error given by Expression (8) above in consideration of the influence of speed.

For this, in the present embodiment, the reward is defined by the following Equation (9).

$$r ( {s}_{t} , {a}_{t} , g ) = - {\int }_{{x}_{t}}^{{x}_{t + 1}} {γ}^{x - {x}_{t}} d ( x ) d x \qquad Equation ( 9 )$$

Equation (8) above is given by the following Expression (10) using the reward given by Equation (9) above.

$$- {\sum }_{k = 0}^{∞} {γ}^{x ( t + k ) - x ( t )} r ( {s}_{t + k} , {a}_{t + k} , g ) \qquad Equation ( 10 )$$

As described above, the goal-conditioned reinforcement learning aims to learn a control policy π(aₜ|sₜ,g) that maximizes the expected value of the discounted cumulative reward given by Formula (1) above. The discount rate γ^{k} at time t+k therefore needs to be replaced by the following Expression (11) in order to maximize the expected value of the discounted cumulative reward given by Expression (10) above.

γ^{x(t+k)-x(t)} Expression (11)

Thus, in the present embodiment, TD learning of the value function V(sₜ,g) is determined by an updating formula given by the following Formula (12).

$$V ( {s}_{t} , g ) ← V ( {s}_{t} , g ) + α [ r ( {s}_{t} , {a}_{t} , g ) + {γ}^{x ( ι + 1 ) - x ( t )} V ( {s}_{t + 1} , g ) - V ( {s}_{f} , g ) ] \qquad Formula ( 12 )$$

Furthermore, in the present embodiment, TD learning of the action value function Q(sₜ,aₜ,g) is determined by an updating formula given by the following Formula (13).

$$Q ( {s}_{t} , {a}_{t} , g ) ← Q ( {s}_{t} , {a}_{t} , g ) + α [ r ( {s}_{t} , {a}_{t} , g ) + {γ}^{x ( t + 1 ) - x ( t )} \int π ( a \vert {s}_{t + 1} v ) Q ( {s}_{t + 1} , a , g ) d a - Q ( {s}_{t} , {a}_{t} , g ) ] \qquad Formula ( 13 )$$

In other words, in the present embodiment, a corrected discount rate in which the discount rate γ is corrected with speed is used, instead of the discount rate Y in Formula (2) above, which is the updating formula for the value function V(sₜ,g), and in Formula (3) above, which is the updating formula for the action value function Q(sₜ,aₜ,g). The corrected discount rate is given by the following Expression (14).

$${γ}^{{x}_{t + 1} - {x}_{t}} \qquad Equation ( 14 )$$

In Expression (14), x₍ₜ₊₁₎−x₍ₜ₎ can also be calculated as v(t)δ_{T} or using a speed v(t) at time t and a control period δ_{T}. In other words, the corrected discount rate can also be given by the following Expression (15).

$${γ}^{v ( t ) {δ}_{T}} \qquad Equation ( 15 )$$

In the present embodiment, Equation (9) above or an approximation of Equation (9) above, such as the following Equations (16) to (19), are used as the corrected reward in which the reward is corrected in accordance with the speed of the control target point included in the observation information.

$$r ( {s}_{t} , {a}_{t} , g ) = - ν ( t ) {δ}_{T} d ( x ( t ) ) \qquad Equation ( 16 )$$

$$r ( {s}_{t} , {a}_{t} , g ) = - v ( t + 1 ) {δ}_{T} d ( x ( t + 1 ) ) \qquad Equation ( 17 )$$

$$r ( {s}_{t} , {a}_{t} , g ) = - ( x ( t + 1 ) - x ( t ) ) d ( x ( t ) ) \qquad Equation ( 18 )$$

$$r ( {s}_{t} , {a}_{t} , g ) = - ( x ( t + 1 ) - x ( t ) ) d ( x ( t + 1 ) ) \qquad Equation ( 19 )$$

In other words, the machine learning device 10 of the present embodiment learns a control policy by reinforcement learning, using the corrected reward in which the reward is corrected in accordance with the speed of the control target point included in the observation information. By using the corrected reward, the machine learning device 10 of the present embodiment can learn a control policy that minimizes the average error.

Furthermore, the machine learning device 10 of the present embodiment learns a control policy by reinforcement learning, using the corrected discount rate in which the discount rate of the reward is corrected in accordance with the travel distance of the control target point, instead of the discount rate of the reward. By using the corrected discount rate, the machine learning device 10 of the present embodiment can prevent change in speed from influencing the value of the discounted cumulative reward and can further learn a control policy that minimizes the average error.

The point at issue with the goal-conditioned reinforcement learning is that it is difficult to obtain an action sequence that achieves the goal g in the early stages of learning, so that the learning involves an enormous amount of action searches. Therefore, in order to further improve the efficiency of the goal-conditioned reinforcement learning, the machine learning device 10 of the present embodiment replaces the goal of an action sequence that failed to achieve a goal and thereby uses the action sequence for learning as an action sequence that has achieved a goal. For example, it is assumed that the action sequence a₀, a₁, a₂, . . . aₜ is executed for achievement of the goal g, but unfortunately, the goal g is not achieved and another goal g′ is achieved. In this case, the action sequence a₀, a₁, a₂, . . . aₜ is a failure case for the goal g, but it can be used for learning as a success case if the goal is replaced with the other goal g′. In this way, the efficiency of learning can be improved not only by learning a failure case as it is, but also by creating a success case by replacing the goal and using the created case for learning.

The machine learning device 10 of the present embodiment therefore can efficiently learn a control policy by setting a plurality of evaluation parameter values as goals.

The configuration of the machine learning device 10 in the present embodiment will now be described in detail.

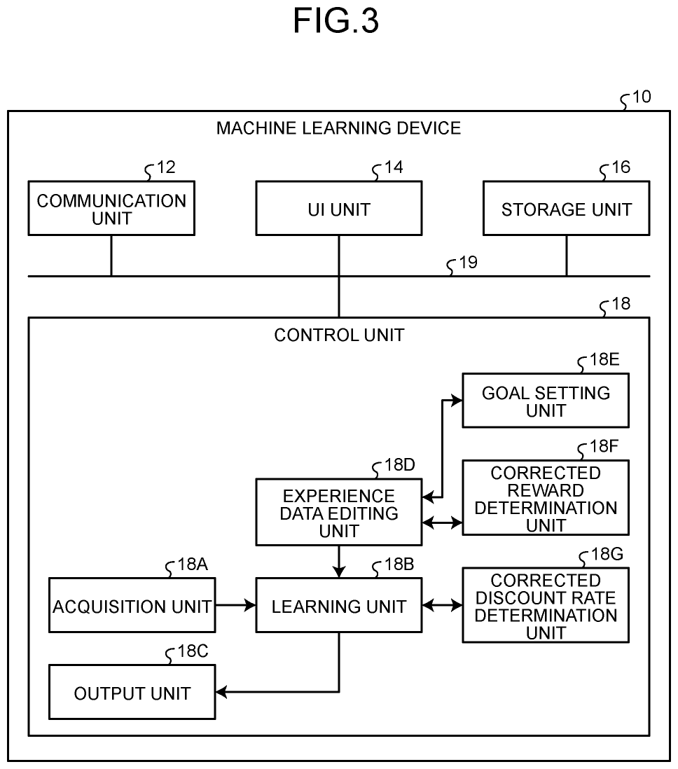

FIG. 3 is a functional block diagram of an example of the machine learning device 10 of the present embodiment.

The machine learning device 10 includes a communication unit 12, a user interface (UI) unit 14, and a storage unit 16. The communication unit 12, the UI unit 14, the storage unit 16, and a control unit 18 are communicably connected via a bus 19 or the like.

The communication unit 12 communicates with an external information processing device such as the control target device 20 via a network or the like. The UI unit 14 has a display function and an input function. The display function displays various kinds of information. The display function is, for example, a display, a projector, and the like. The input function accepts an operation input by the user. The input function is, for example, a pointing device such as a mouse and a touchpad, and a keyboard. The display function and the input function may be integrally formed as a touch panel. The storage unit 16 stores therein various kinds of information.

The UI unit 14 and the storage unit 16 are communicably connected to the control unit 18 by wire or by radio. At least one of the UI unit 14 and the storage unit 16 may be connected to the control unit 18 via a network or the like.

At least one of the UI unit 14 and the storage unit 16 may be provided outside of the machine learning device 10. At least one of one or more functions included in the UI unit 14, the storage unit 16, and the control unit 18 may be installed in an external information processing device communicably connected to the machine learning device 10 via a network or the like.

The control unit 18 performs information processing in the machine learning device 10. The control unit 18 includes an acquisition unit 18A, a learning unit 18B, an output unit 18C, an experience data editing unit 18D, a goal setting unit 18E, a corrected reward determination unit 18F, and a corrected discount rate determination unit 18G.

The acquisition unit 18A, the learning unit 18B, the output unit 18C, the experience data editing unit 18D, the goal setting unit 18E, the corrected reward determination unit 18F, and the corrected discount rate determination unit 18G are implemented, for example, by one or more processors. For example, the above units may be implemented by allowing a processor such as a central processing unit (CPU) to execute a computer program, that is, by software. The above units may be implemented by a processor such as a dedicated IC, that is, by hardware. The above units may be implemented by a combination of software and hardware. When a plurality of processors are used, each processor may implement one of the units or may implement two or more of the units.

The acquisition unit 18A acquires observation information. As described above, the observation information is information that represents a state of a control target point at control target time t and includes information on the speed of the control target point at control target time t. The observation information also includes a goal g for an evaluation parameter. The acquisition unit 18A sequentially acquires the observation information sequentially output from the control target device 20 for each control target time t. Every time the acquisition unit 18A acquires observation information at control target time t, the acquisition unit 18A outputs the acquired observation information to the learning unit 18B.

The learning unit 18B performs processing such as extraction of some pieces of data, scaling, and clipping for the observation information at control target time t accepted from the acquisition unit 18A to convert the observation information into a state sₜ for use in reinforcement learning. When the observation information includes an image, the learning unit 18B may perform image processing or image recognition processing.

Subsequently, the learning unit 18B determines an action aₜ, using the present control policy π(aₜ|sₜ,g), for the observation information at control target time t accepted from the acquisition unit 18A.

Specifically, the learning unit 18B identifies the control policy π(aₜ|sₜ,g) by extracting the goal g from the observation information. The learning unit 18B then samples actions aₜ in accordance with the control policy π(aₜ|sₜ, g) represented by a probability distribution. The learning unit 18B may determine the action aₜ with the maximum probability. When the control policy π(aₜ|sₜ, g) is configured to output the action aₜ directly from the state sₜ and the goal g, the learning unit 18B may directly determine the action aₜ using the state sₜ, the goal g, and the control policy π(aₜ|sₜ,g). The learning unit 18B may randomly sample actions aₜ without using the control policy π(aₜ|sₜ,g) for a certain period of time from the start.

The learning unit 18B outputs the action aₜ determined by these processes to the output unit 18C.

The output unit 18C outputs control information including information on speed control of the control target point that is determined in accordance with the observation information and the control policy. More specifically, the output unit 18C accepts the action aₜ from the learning unit 18B. The output unit 18C converts the action aₜ into control information by performing processing such as scaling for the action aₜ accepted from the learning unit 18B, and outputs the control information to the control target device 20.

The learning unit 18B stores data used for learning as experience data into the storage unit 16. Specifically, the learning unit 18B stores the experience data including the goal g, the achieved values of the evaluation parameter f(x(t)), the speed v(t) or speed x(t)−x(t−1) of the control target point, the state sₜ₋₁ before one control time, and the action aₜ₋₁ before one control time, as the experience data corresponding to control target time t, into the storage unit 16.

Depending on some reinforcement learning algorithms that are used, the learning unit 18B may store the experience data further including the state sₜ, the value of the value function V(sₜ,g), the value of the action value function Q(sₜ,aₜ,g), the probability value π(aₜ₋₁|sₜ₋₁,g) of the action aₜ₋₁ into the storage unit 16.

The learning unit 18B further performs a process of updating the control policy π(aₜ|sₜ,g), the value function V(sₜ,g), and the action value function Q(sₜ,aₜ,g) at a certain frequency. This updating process corresponds to learning. This learning will be described in detail below.

The storage unit 16 stores the experience data input from the learning unit 18B up to a predetermined maximum number of pieces of experience data. When the experience data stored in the storage unit 16 exceeds the maximum number, the control unit 18 discards the earliest experience data.

When the learning unit 18B performs a process of updating the control policy π(aₜ|sₜ,g), the value function V(sₜ,g), and the action value function Q(sₜ,aₜ,g), the experience data editing unit 18D randomly samples a certain number (M) of pieces of experience data from the storage unit 16. M is an integer equal to or greater than 1. The experience data editing unit 18D sets control target time t corresponding to each of M pieces of sampled experience data as a reference, and identifies another experience data corresponding to another control target time t′ within a predetermined period of time from the reference control target time t, as a neighboring experience data series corresponding to each of M pieces of experience data.

The experience data editing unit 18D then uses M pieces of sampled experience data and the neighboring experience data series corresponding to each of M pieces of experience data to generate MK pieces of edited experience data to be used by the learning unit 18B for learning. K is an integer equal to or greater than 1.

Specifically, the experience data editing unit 18D outputs, to the goal setting unit 18E, M pieces of sampled experience data and the neighboring experience data series corresponding to each of M pieces of experience data.

Based on a group of: first experience data including an evaluation parameter f(x(t)) derived from the observation information acquired by the acquisition unit 18A; and one or more pieces of second experience data each including an evaluation parameter f(x(t′)) derived from one or more pieces of other observation information aₜ control target time t′ different from the acquired observation information, the goal setting unit 18E sets a plurality of evaluation parameter values selected from a plurality of evaluation parameter values included in the group as goals gⱼ.

The first experience data corresponds to M pieces of sampled experience data. The second experience data corresponds to the neighboring experience data series corresponding to each of M pieces of experience data.

Specifically, the goal setting unit 18E determines K goals gⱼ for each of M pieces of experience data accepted from the experience data editing unit 18D. j is given by the following Equation (20).

$$j = 0 , 1 , … , k - 1 \qquad Equation ( 20 )$$

First, for each of M pieces of experience data, the goal setting unit 18E sets the goal g included in the experience data as a goal go (j=0). Next, the goal setting unit 18E randomly samples K-1 values of the evaluation parameter f(x(t′)) included in the second experience data, which is the experience data that constitutes the neighboring experience data series corresponding to each of M pieces of experience data, and determines K-1 goals gⱼ (j=1, 2, . . . , K−1). With these processes, the goal setting unit 18E sets K goals gⱼ (j=0, 1, 2, . . . , K−1) for each of M pieces of experience data.

The goal setting unit 18E may limit the sampling range of K-1 values of the evaluation parameter f(x(t′)) to the values of the evaluation parameter f(x(t′)) achieved at control target time t′ in the future from control target time t of experience data.

The goal setting unit 18E may add noise to each of K-1 values of the evaluation parameter f(x(t′)) sampled from the values of the evaluation parameter f(x(t′)) included in the second experience data, and set the noise-added values of the evaluation parameter as K-1 goals gⱼ (j=1, 2, . . . , K−1). Noise generated according to a probability distribution such as Gaussian or uniform distribution can be used as the noise.

Instead of the second experience data which is the experience data that constitutes the neighboring experience data series corresponding to each of M pieces of experience data (first experience data), the goal setting unit 18E may set values randomly selected from the possible range of the evaluation parameter f(x(t)) included in each of M pieces of experience data, as K-1 goals gⱼ (j=1, 2, . . . , K−1).

The goal setting unit 18E may set K goals gⱼ (j=1, 2, . . . , K−1) according to a goal selecting method selected by the user. The goal setting unit 18E may sample K-1 goals gⱼ (j=1, 2, . . . , K−1), where K-1 is the number selected by the user.

For example, the goal setting unit 18E displays a display screen on the UI unit 14 to accept inputs of a goal selecting method and the number of selections of goals.

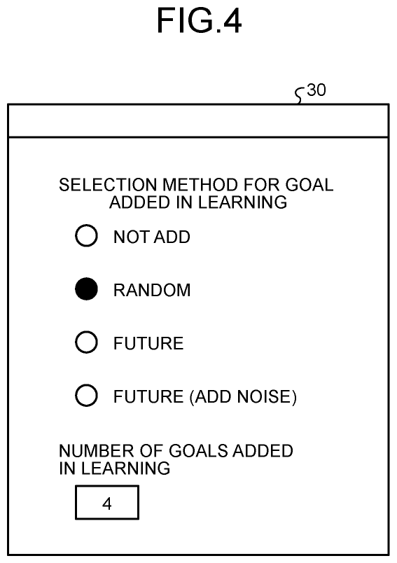

FIG. 4 is a schematic diagram of an example of a display screen 30. For example, the goal setting unit 18E displays the display screen 30 on the UI unit 14.

The display screen 30 includes a field for selecting a goal selecting method and an entry field for the number of selections of goals gⱼ.

Examples of the goal selecting method include “not add”, “random”, “future”, and “future (add noise)”. “Not add” indicates that a new goal gⱼ other than the goal g included in the experience data is not to be added. “Random” indicates random selection. “Future” indicates selection from the values of the evaluation parameter f(x(t′)) included in the second experience data corresponding to control target time t′ in the future from control target time t corresponding to the experience data. “Future (add noise)” indicates that noise is to be added to the value of the evaluation parameter f(x(t′)) included in the second experience data corresponding to control target time t′ in the future.

The entry field for the number of selections of goals gⱼ in the display screen 30 indicates the number of selections K-1 to be selected from the values of the evaluation parameter of the second experience data.

The user inputs the goal selecting method and the number of selections of goals as desired by operating the UI unit 14 while viewing the display screen 30. The goal setting unit 18E may select K-1 goals gⱼ input by the user from the values of the evaluation parameter of the second experience data, in accordance with the goal selecting method selected by the user through the display screen 30.

For example, assume a situation in which the user selects “not add” through the display screen 30. In this case, the goal setting unit 18E selects only the goals g included in M pieces of experience data as goals gⱼ and does not select any other goals. In this case, therefore, K is forcedly set to 1.

Assume a situation in which the user selects “random”. In this case, the goal setting unit 18E may randomly sample K-1 values of the evaluation parameter f(x(t′)) achieved included in each of the second experience data, which is the experience data that constitutes the neighboring experience data series corresponding to each of M pieces of experience data (first experience data). Then, the goal setting unit 18E may add the sampled values of the evaluation parameter f(x(t′)) as goal j (j=1, 2, . . . , K−1).

Assume a situation in which the user selec″s “fut″re”. In this case, for M pieces of experience data (first experience data), the goal setting unit 18E may randomly sample K-1 values of the evaluation parameter f(x(t′)) achieved in the experience data (second experience data) aₜ control target time t′ in the future from M pieces of experience data. Then, the goal setting unit 18E may add the sampled value of the evaluation parameter f(x(t′)) as goal j (j=1, 2, . . . , K−1).

Assume a situation in which the user selects “future (add noise)”. In this case, for M pieces of experience data (first experience data), the goal setting unit 18E randomly samples K-1 values of the evaluation parameter f(x(t′)) achieved in the experience data (second experience data) at control target time t′ in the future from M pieces of experience data. Then, the goal setting unit 18E may add noise to the sampled value of the evaluation parameter f(x(t′)) and add the noise-added value of the evaluation parameter as goal j (j=1, 2, . . . , K−1). Noise generated according to a probability distribution such as Gaussian distribution can be used as the noise as described above.

When the goals gⱼ selected by the goal setting unit 18E are all similar to the goal g included in the first experience data, the contribution to improving learning efficiency is reduced. However, learning efficiency can be improved by adding a noise-added value of the evaluation parameter as a goal j and thereby increasing the variations of values of the goal gⱼ.

As described above, the entry field for the number of selections of goals g; in the display screen 30 indicates the number of selections K-1 to be selected from the values of the evaluation parameter of the second experience data. The goal setting unit 18E may sample K-1 goals gⱼ (j=1, 2, . . . , K−1) by selecting K-1 goals gⱼ from the values of the evaluation parameter of the second experience data, where K-1 is the number of selections input by the user through the display screen 30.

Returning to FIG. 3, the description will be continued. With the above process by the goal setting unit 18E, K goals gⱼ (j=0, 1, 2, . . . , K−1) are selected for each of M pieces of experience data.

The goal setting unit 18E outputs, to the experience data editing unit 18D, K goals gⱼ set for each of M pieces of experience data (j=0, 1, 2, . . . , K−1), that is, MK goals gⱼ.

For each of M pieces of experience data, the experience data editing unit 18D outputs, to the corrected reward determination unit 18F, the evaluation parameter f(x(t+1)) and the speed information v(t+1) or the speed information x(t+1)−x(t) included in each of M pieces of experience data, and K goals gⱼ (j=0, 1, 2, . . . , K−1) accepted from the goal setting unit 18E.

The corrected reward determination unit 18F determines a corrected reward in which the reward that is higher as the error between the goal g; and the value of the evaluation parameter f(x(t+1)) other than a speed derived from the observation information is smaller is corrected in accordance with the speed of the control target point included in the observation information.

Specifically, the corrected reward determination unit 18F determines a corrected reward in which the reward is corrected such that the higher the speed of the control target point, the lower the reward.

In the present embodiment, for each of K goals gⱼ (j=0, 1, 2, . . . , K−1) set by the goal setting unit 18E, the corrected reward determination unit 18F calculates a reward that is higher as the error between the value of the evaluation parameter f(x(t+1)) derived from the acquired observation information and each of K goals gⱼ (j=0, 1, 2, . . . , K−1) is smaller. Then, the corrected reward determination unit 18F determines a corrected reward in which the calculated reward is corrected in accordance with the speed information of the control target point included in the observation information.

Specifically, the corrected reward determination unit 18F calculates a corrected reward, using the evaluation parameter f(x(t+1)) and the speed information v(t+1) or the speed information x(t+1)−x(t) included in the experience data and K goals gⱼ (j=0, 1, 2, . . . , K−1) corresponding to the experience data that are accepted from the experience data editing unit 18D.

In calculation of a corrected reward, Equation (9) above or the approximation of Equation (9) above, such as Equations (16) to (19) above, are used. The corrected reward determination unit 18F may calculate d(x(t+1)) in these equations, using the L1 or L2 distance between each of the goals gⱼ (j=0, 1, 2, . . . , K−1) and the evaluation parameter f(x(t+1)) included in the experience data.

The corrected reward determination unit 18F determines the corrected reward by calculating the corrected reward. The corrected reward determination unit 18F may determine the corrected reward by accepting the corrected reward calculated by an external device or the like for calculating the corrected reward.

The corrected reward determination unit 18F outputs, to the experience data editing unit 18D, the corrected reward r(sₜ,aₜ,gⱼ) corresponding to each of K goals gⱼ (j=0, 1, 2, . . . , K−1) that is determined for each of M pieces of experience data.

For each of M pieces of experience data, the experience data editing unit 18D generates edited experience data including the state sₜ, the action aₜ, the evaluation parameter f(x(t+1)), and the speed information v(t+1) or the speed information x(t+1)−x(t) included in the experience data, the goal gⱼ accepted from the goal setting unit 18E, and the corrected reward r(sₜ,aₜ,gⱼ) corresponding to the goal gⱼ accepted from the corrected reward determination unit 18F. In other words, the experience data editing unit 18D generates K pieces of edited experience data in which K goals g; are set instead of the goal g for one experience data, and a corrected reward r(sₜ,aₜ,gⱼ) is further set for each of K goals gⱼ. The experience data editing unit 18D then outputs MK pieces of edited experience data generated from M pieces of experience data to the learning unit 18B.

The learning unit 18B learns the control policy π(aₜ|sₜ,g) from the observation information and the corrected reward r(sₜ,aₜ,gⱼ) by reinforcement learning.

In other words, the learning unit 18B performs a process of updating the control policy π(aₜ|sₜ,g), the value function V(sₜ,g), and the action value function Q(sₜ,aₜ,g), using MK pieces of edited experience data accepted from the experience data editing unit 18D.

First, the learning unit 18B outputs, to the corrected discount rate determination unit 18G, the speed information v(t+1) or the speed information x(t+1)−x(t) included in each of MK pieces of edited experience data accepted from the experience data editing unit 18D.

The corrected discount rate determination unit 18G determines a corrected discount rate in which the discount rate γ of the corrected reward is corrected in accordance with the speed of the control target point derived from the observation information. Specifically, the corrected discount rate determination unit 18G determines a corrected discount rate in which the discount rate is corrected such that the higher the speed of the control target point, the greater the discount (that is, the smaller the value of the discount rate γ).

Specifically, the corrected discount rate determination unit 18G calculates the power of the discount rate γ as the corrected discount rate, where the speed information v(t+1) or the speed information x(t+1)−x(t) is the exponent of the power. In other words, the corrected discount rate determination unit 18G calculates the corrected discount rate at control target time t+1 according to the following Expression (21) or (22).

$${γ}^{ν ( t + 1 ) {δ}_{T}} \qquad Expression ( 21 )$$

$${γ}^{x ( t + 1 ) - x ( t )} \qquad Expression ( 22 )$$

The corrected discount rate determination unit 18G may determine a corrected discount rate in which the discount rate in accordance with the input discount rate for the input speed that has been input is corrected in accordance with the speed of the control target point.

The user may directly input the input discount rate by operating the UI unit 14, but it is difficult to intuitively understand how much the reward is discounted. It is therefore preferable that the corrected discount rate determination unit 18G displays a display screen on the UI unit 14 so that the input discount rate can be set more intuitively.

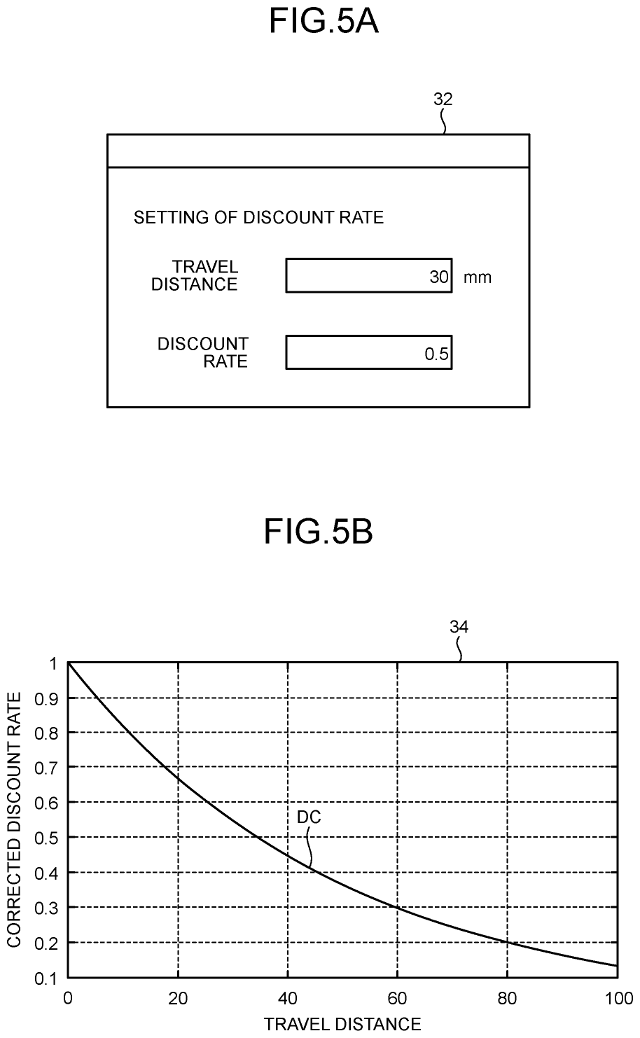

FIG. 5A is a schematic diagram of an example of a display screen 32. The corrected discount rate determination unit 18G displays the display screen 32 on the UI unit 14. The display screen 32 includes an entry field for travel distance per unit time and an entry field for input discount rate for the travel distance (labeled as “discount rate” in the display screen 32). FIG. 5A illustrates an entry field for travel distance per unit time as an example of the entry field for input speed. However, the display screen 32 may have an entry field for speed, instead of the entry field for travel distance per unit time. The display screen 32 has an entry field for input speed such as travel distance per unit time or speed in addition to the input discount rate to indicate how much the reward is discounted for the speed, thereby enabling the user to input the desired discount rate for the speed (travel distance per unit time) more intuitively.

By operating the UI unit 14 while viewing the display screen 32, the user inputs a travel distance per unit time and an input discount rate, which is the rate at which the error and the reward are discounted in the input travel distance.

Assume a situation in which the user inputs a travel distance X and an input discount rate G desired by the user for the input travel distance X through an operation instruction on the UI unit 14.

In this case, the corrected discount rate determination unit 18G calculates a discount rate γ from the input discount rate G at the travel distance X, according to the following Equation (23).

$$γ = {G}^{1 / X} \qquad Equation ( 23 )$$

The corrected discount rate determination unit 18G then may calculate a corrected discount rate using the discount rate γ calculated by Equation (23) and Expression (14) or (15) above. With these calculations, the corrected discount rate determination unit 18G determines the corrected discount rate.

For confirmation, the corrected discount rate determination unit 18G may display, on the UI unit 14, correspondence information representing the correspondence between the determined corrected discount rate and the travel distance per unit time.

FIG. 5B is a schematic diagram of an example of a display screen 34. For example, the corrected discount rate determination unit 18G displays the display screen 34 on the UI unit 14. The display screen 34 includes a graph including a line DC representing the correspondence between the corrected discount rate and the travel distance as the correspondence information. The correspondence information is not limited to a graph and may be any information that represents the correspondence between the corrected discount rate and the travel distance.

In this way, the corrected discount rate determination unit 18G may determine a corrected discount rate in which the discount rate γ in accordance with the input discount rate for the input speed that has been input by the user is corrected in accordance with the speed of the control target point. When the conditions of the control target device 20, such as the environment of the unmanned movable body or the robot, or the material of the laser welding, change, the appropriate discount rate may also change. Since the discount rate can be set and changed by the user, the corrected discount rate determination unit 18G can determine a corrected discount rate in accordance with the conditions of the control target device 20.

Returning to FIG. 3, the description will be continued. The corrected discount rate determination unit 18G outputs the calculated corrected discount rate to the learning unit 18B.

The learning unit 18B performs a process of updating (learning) the control policy π(aₜ|sₜ,g), the value function V(sₜ,g), and the action value function Q(sₜ,aₜ,g), using MK pieces of edited experience data accepted from the experience data editing unit 18D and the corrected discount rate accepted from the corrected discount rate determination unit 18G.

When a reinforcement learning algorithm called an on-policy method is used, the learning unit 18B may sample the experience data at a timing, such as a timing when a certain number of pieces of experience data is stored in the storage unit 16, or a timing when the flying of the drone or the welding is finished, and perform the updating process using the edited experience data generated based on the experience data.

On the other hand, when a reinforcement learning algorithm called an off-policy method is used, the learning unit 18B may sample a certain number of pieces of experience data from the storage unit 16 every time or once a few times and perform the updating process using the edited experience data generated based on the experience data. In the off-policy method, the experience data may be stored in the storage unit 16 until a predetermined maximum number of pieces of experience data is reached, and when the maximum number is exceeded, the earliest experience data may be discarded.

The learning unit 18B can use any reinforcement learning algorithm to update the control policy π(aₜ|sₜ,g), the value function V(sₜ,g), and the action value function Q(sₜ,aₜ,g). In the present embodiment, it is preferable that the learning unit 18B performs the updating process for them, using the corrected discount rate accepted from the corrected discount rate determination unit 18G, instead of the discount rate γ. For example, when aₜ least one of the value function V(sₜ,g) and the action value function Q(sₜ,aₜ,g) is learned by TD learning, the learning unit 18B may update the value function V(sₜ,g) and the action value function Q(sₜ,aₜ,g) using Formulas (2) and (3) above.

The learning unit 18B may perform the process in accordance with the reinforcement learning algorithm used, except that the corrected discount rate is used instead of the discount rate γ.

An example of the information processing performed by the machine learning device 10 of the present embodiment will now be described.

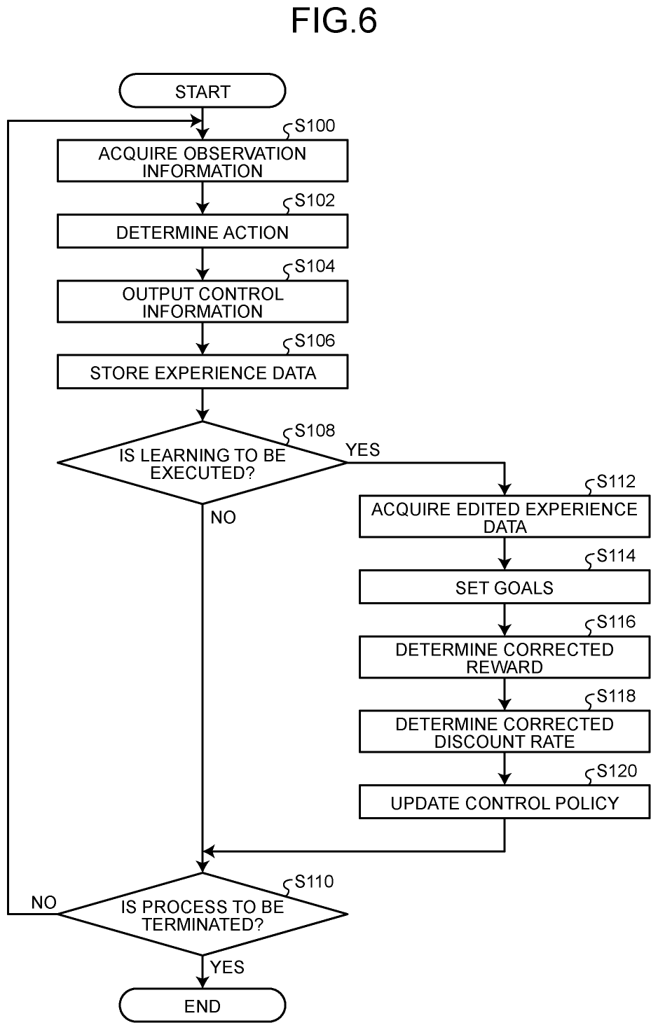

FIG. 6 is a flowchart illustrating an example flow of the information processing performed by the machine learning device 10 of the present embodiment.

The acquisition unit 18A acquires the observation information aₜ control target time t from the control target device 20 (step S100).

The learning unit 18B calculates a state sₜ and a goal g from the observation information acquired aₜ step S100 and determines an action aₜ (step S102). The output unit 18C converts the action aₜ determined at step S102 into control information and outputs the control information to the control target device 200 (step S104).

The learning unit 18B stores data corresponding to the observation information at control target time t acquired at step S100 into the storage unit 16 (step S106). As described above, the experience data includes the goal g, the achieved value of the evaluation parameter f(x(t)), the speed v(t) which is the speed information of the control target point or the speed (speed expressed by a travel distance per unit time, where one control cycle is the unit) x(t)−x(t−1), and the state sₜ₋₁ before one control time, and the action aₜ₋₁.

The learning unit 18B determines whether it is the timing to execute learning (step S108). In other words, the learning unit 18B determines whether it is the timing to perform the process of updating the control policy π(aₜ|sₜ,g), the value function V(sₜ,g), and the action value function Q(sₜ, aₜ, g). For example, the learning unit 18B performs the updating process every certain control target time. In this case, the learning unit 18B performs the determination at step S108 by determining whether a period of time for a certain control target time has elapsed since the previous learning execution.

If the determination result is negative at step S108 (No at step S108), the process proceeds to step S110. At step S110, the control unit 18 determines whether to terminate the process (step S110). If the determination is positive at S110 (Yes at step S110), this routine is terminated. If the determination result is negative at step S110 (No at step S110), the process return to step S100 above.

On the other hand, if the learning unit 18B determines that it is the timing to execute learning (Yes at step S108), the process proceeds to step S112.

At step S112, the experience data editing unit 18D acquires M pieces of experience data by randomly sampling a certain number (M) of pieces of experience data from the storage unit 16 (step S112). The experience data editing unit 18D outputs, to the goal setting unit 18E, M pieces of sampled experience data and the neighboring experience data series corresponding to each of M pieces of experience data.

Based on a group of: the first experience data that is M pieces of experience data acquired at step S112; and the second experience data that constitutes the neighboring experience data series corresponding to each of M pieces of experience data, the goal setting unit 18E sets K values of the evaluation parameter selected from a plurality of values of the evaluation parameter included in the group, as K goals gⱼ (j=0, 1, 2, . . . , K−1) (step S114).

For each of M pieces of experience data, the experience data editing unit 18D outputs, to the corrected reward determination unit 18F, the evaluation parameter f(x(t+1)) and the speed information v(t+1) or the speed information x(t+1)−x(t) included in each of M pieces of experience data, and K goals gⱼ (j=0, 1, 2, . . . , K−1) accepted from the goal setting unit 18E.

The corrected reward determination unit 18F determines a corrected reward r(sₜ,aₜ,gⱼ), using the evaluation parameter f(x(t+1)) and the speed information v(t+1) or the speed information x(t+1)−x(t) included in the experience data acquired at step S112, and K goals gⱼ (j=0, 1, 2, . . . , K−1) set at step 114 corresponding to the experience data (step S116).

For each of M pieces of experience data, the experience data editing unit 18D generates edited experience data including the state sₜ, the action aₜ, the evaluation parameter f(x(t+1)), and the speed information v(t+1) or the speed information x(t+1)−x(t) included in the experience data, the goal gⱼ accepted from the goal setting unit 18E, and the corrected reward r(sₜ,aₜ,gⱼ) corresponding to the goal gⱼ accepted from the corrected reward determination unit 18F. The experience data editing unit 18D then outputs MK pieces of edited experience data generated from M pieces of experience data to the learning unit 18B. The learning unit 18B outputs, to the corrected discount rate determination unit 18G, the speed information v(t+1) or the speed information x(t+1)−x(t) included in each of MK pieces of edited experience data accepted from the experience data editing unit 18D.

The corrected discount rate determination unit 18G calculates the power of the discount rate γ as a corrected discount rate, where the speed information v(t+1) or the speed information x(t+1)−x(t) accepted from the learning unit 18B is the exponent of the power (step S118).

The learning unit 18B performs a process of updating (learning) the control policy π(aₜ|sₜ,g), the value function V(sₜ,g), and the action value function Q(sₜ,aₜ,g), using MK pieces of edited experience data accepted from the experience data editing unit 18D and the corrected discount rate accepted from the corrected discount rate determination unit 18G (step S120). The process then proceed to step S110 above.

As described above, the machine learning device 10 of the present embodiment includes the acquisition unit 18A, the output unit 18C, the corrected reward determination unit 18F, and the learning unit 18B. The acquisition unit 18A acquires observation information including information on the speed of the control target point at a control target time. The output unit 18C outputs control information including information on speed control of the control target point that is determined in accordance with the observation information and the control policy. The corrected reward determination unit 18F determines a corrected reward in which a reward that is higher as the error between the goal and the value of the evaluation parameter other than a speed derived from the observation information is smaller is corrected in accordance with the speed of the control target point included in the observation information. The learning unit 18B learns a control policy from the observation information and the corrected reward by reinforcement learning.

In this way, the machine learning device 10 of the present embodiment learns a control policy by reinforcement learning, using a corrected reward in which the reward is corrected in accordance with the speed of the control target point included in the observation information. By using the corrected reward that is corrected in accordance with the speed, the machine learning device 10 of the present embodiment can learn a control policy that minimizes the average error with respect to the goal of the control target point including speed control.

The machine learning device 10 of the present embodiment therefore can minimize the average error with respect to the goal of the control target point including the speed control.

Furthermore, the machine learning device 10 of the present embodiment learns a control policy by reinforcement learning, using a corrected discount rate in which the discount rate of the reward is corrected in accordance with the travel distance of the control target point, instead of the discount rate of the reward. By using the corrected discount rate, the machine learning device 10 of the present embodiment can prevent change in speed from influencing the value of the discounted cumulative reward and can further learn a control policy that minimizes the average error.

The machine learning device 10 of the present embodiment further includes the goal setting unit 18E. Based on a group of: first experience data including an evaluation parameter derived from the acquired observation information; and one or more pieces of second experience data each including an evaluation parameter derived from one or more pieces of other observation information different in control target time from the acquired observation information, the goal setting unit 18E sets K values of the evaluation parameter selected from a plurality of evaluation parameter values included in the group, as K goals gⱼ.

Then, for each of the set K goals gⱼ, the corrected reward determination unit 18F determines a corrected reward in which a reward that is higher as the error between the value of the evaluation parameter derived from the acquired observation information and each of K goals gⱼ is smaller is corrected in accordance with the speed of the control target point. The learning unit 18B then performs reinforcement learning based on the edited experience data including the goal gⱼ accepted from the goal setting unit 18E and the corrected reward r(sₜ,aₜ,gⱼ) corresponding to the goal g; accepted from the corrected reward determination unit 18F.

Thus, the learning unit 18B can use the edited experience data in which the value of the evaluation parameter achieved as a consequence is set as the goal gⱼ, for learning, in addition to the goal g set when the action aₜ is determined. Thus, the machine learning device 10 in the present embodiment can significantly increase learning efficiency, in addition to the above effects.

### Modifications

In the foregoing embodiment, the control unit 18 includes the goal setting unit 18E and the corrected discount rate determination unit 18G, as an example. However, the control unit 18 does not necessarily include at least one of the goal setting unit 18E and the corrected discount rate determination unit 18G.

In the configuration that does not include the goal setting unit 18E, the corrected reward determination unit 18F may determine a corrected reward for each of M pieces of experience data, using the goal g included in each of M pieces of experience data acquired by the experience data editing unit 18D, instead of K goals gⱼ (j=0, 1, 2, . . . , K−1).

In the configuration that does not include the corrected discount rate determination unit 18G, the learning unit 18B may perform a process of updating (learning) the control policy π(aₜ|sₜ,g), the value function V(sₜ,g), and the action value function Q(sₜ,aₜ,g) using the discount rate γ that is the discount rate before correction, instead of the corrected discount rate. Specifically, in this case, the learning unit 18B may use Formulas (2) and (3) above to update the value function V(sₜ,g) and the action value function Q(sₜ,aₜ,g). This is an approximation method by replacing Formulas (12) and (13) above with Formulas (2) and (3) above, respectively, and is effective when the change in speed is small. This method is advantageous in that existing reinforcement learning processes can be applied as they are.

An example of the hardware configuration of the machine learning device 10 of the foregoing embodiment will now be described.

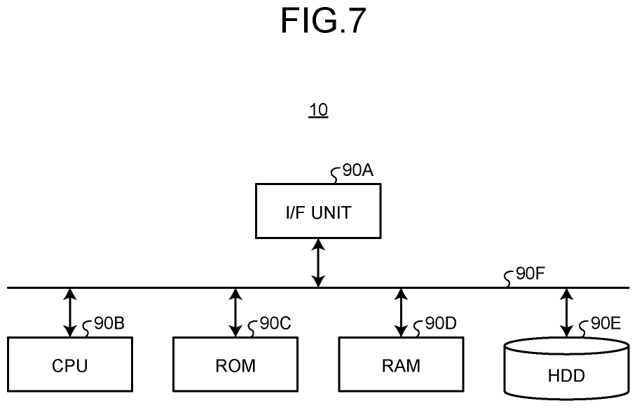

FIG. 7 is a hardware configuration diagram of an example of the machine learning device 10 of the foregoing embodiment.

The machine learning device 10 of the foregoing embodiment has a hardware configuration using a general computer, including a control device such as a central processing unit (CPU) 90B, a storage device such as a read-only memory (ROM) 90C, a random-access memory (RAM) 90D, and a hard disk drive (HDD) 90E, an I/F unit 90A that is an interface to various devices, and a bus 90F connecting the units.

In the machine learning device 10 of the foregoing embodiment, the CPU 90B reads a computer program from the ROM 90C into the RAM 90D and executes the computer program to implement the above units on the computer.

A computer program for causing the above processes to be performed in the machine learning device 10 of the foregoing embodiment may be stored in the HDD 90E. The computer program for causing the above processes to be performed in the machine learning device 10 of the foregoing embodiment may be embedded in the ROM 90C in advance.

The computer program for causing the above processes to be performed in the machine learning device 10 of the foregoing embodiment may be stored in a computer-readable storage medium such as a CD-ROM, a CD-R, a memory card, a digital versatile disc (DVD), and a flexible disk (FD) in the form of a file in an installable format or an executable format and provided as a computer program product. The computer program for causing the above processes to be performed in the machine learning device 10 of the foregoing embodiment may be stored in a computer connected to a network such as the Internet and downloaded via the network. The computer program for causing the above processes to be performed in the machine learning device 10 of the foregoing embodiment may be provided or distributed via a network such as the Internet.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A machine learning device comprising:
an acquisition unit configured to acquire observation information including information on a speed of a control target point aₜ a control target time;
an output unit configured to output control information including information on speed control of the control target point, the control information being determined in accordance with the observation information and a control policy;
a corrected reward determination unit configured to determine a corrected reward obtained by correcting a reward in accordance with a speed of the control target point derived from the observation information, the reward being higher as an error between a value of an evaluation parameter and a goal is smaller, the evaluation parameter being a parameter other than a speed derived from the observation information; and
a learning unit configured to perform reinforcement learning of the control policy based on the observation information and the corrected reward.

2. The device according to claim 1, wherein the corrected reward determination unit configured to determine the corrected reward that is corrected so as to be lower as a speed of the control target point is higher.

3. The device according to claim 1, further comprising a corrected discount rate determination unit configured to determine a corrected discount rate obtained by correcting a discount rate of the corrected reward in accordance with a speed of the control target point derived from the observation information, wherein
the learning unit is configured to perform reinforcement learning of the control policy based on the observation information, the corrected reward, and the corrected discount rate.

4. The device according to claim 3, wherein the corrected discount rate determination unit is configured to determine the corrected discount rate that is corrected such that a value of the discount rate is smaller as the speed of the control target point is higher.

5. The device according to claim 3, wherein the corrected discount rate determination unit is configured to determine the corrected discount rate obtained by correcting, in accordance with the speed of the control target point, the discount rate in accordance with an input discount rate for an input speed that has been input.

6. The device according to claim 1, further comprising a goal setting unit configured to set, as goals, a plurality of evaluation parameter values, based on a group consisting of: first experience data including a value of an evaluation parameter derived from the acquired observation information; and one or more pieces of second experience data including values of an evaluation parameter derived from one or more pieces of other observation information different in control target time from the acquired observation information, each of the plurality of evaluation parameter values selected from a plurality of evaluation parameter values included in the group, wherein
the corrected reward determination unit is configured to determine, for the set goals, corrected rewards obtained by correcting rewards in accordance with the speed of the control target point included in the observation information, the rewards being higher as errors between the values of the evaluation parameter derived from the acquired observation information and the goals are smaller.

7. The device according to claim 6, wherein the goal setting unit is configured to set, as the goals, the value of the evaluation parameter included in the first experience data, and a noise-added value of an evaluation parameter in which noise is added to a value of an evaluation parameter included in the second experience data.

8. The device according to claim 6, wherein the goal setting unit is configured to set the goals in accordance with a goal selecting method selected by a user.

9. The device according to claim 6, wherein the goal setting unit is configured to set the goals, a number of which is selected by a user.

10. A machine learning method comprising:
acquiring observation information including information on a speed of a control target point aₜ a control target time;
outputting control information including information on speed control of the control target point, the control information being determined in accordance with the observation information and a control policy;
determining a corrected reward obtained by correcting a reward in accordance with a speed of the control target point included in the observation information, the reward being higher as an error between a value of an evaluation parameter and a goal is smaller, the evaluation parameter being a parameter other than a speed derived from the observation information; and
performing reinforcement learning of the control policy based on the observation information and the corrected reward.

11. A computer program product comprising a computer-readable medium including programmed instructions, the instructions causing a computer to execute:
acquiring observation information including information on a speed of a control target point aₜ a control target time;
outputting control information including information on speed control of the control target point, the control information being determined in accordance with the observation information and a control policy;
determining a corrected reward obtained by correcting a reward in accordance with a speed of the control target point included in the observation information, the reward being higher as an error between a value of an evaluation parameter and a goal is smaller, the evaluation parameter being a parameter other than a speed derived from the observation information; and
performing reinforcement learning of the control policy based on the observation information and the corrected reward.
